(19) United States
(12) Patent Application Publication
(10) Pub. No.: US 2011/0303762 A1
(43) Pub. Date: Dec. 15, 2011

(54) PIEZOELECTRIC FOAMING PUMP

(75) Inventors: Jackson Wegelin, Stow, OH (US); Keith Allen Pelfrey, Wadsworth, OH (US); Richard Sayers, Akron, OH (US)

(73) Assignee: GOJO INDUSTRIES, INC., Akron, OH (US)

(21) Appl. No.: 13/156,626

(22) Filed: Jun. 9, 2011

Related U.S. Application Data
(60) Provisional application No. 61/353,328, filed on Jun. 10, 2010.

(51) Int. Cl. B05B 1/08

(52) U.S. Cl. 239/102.2; 222/190

(57) ABSTRACT

A piezoelectric foaming pump is provided herein. The piezoelectric foaming pump includes a housing having a first opening for receiving a liquid from a liquid container and a piezoelectric element secured to the housing. The piezoelectric element includes a plurality of holes there through. In addition, the housing includes an air inlet. Although the piezoelectric element has holes there through, prior to activating the piezoelectric element, liquid does not pass through the plurality of holes. When the piezoelectric element is energized, liquid passes through the plurality of holes due to the rapid vibration of the piezoelectric element and is dispensed as a foam. Additionally, a piezoelectric foaming pump having a fluid pump chamber; an air pump chamber; a mixing chamber; a piezoelectric element; and an outlet nozzle is disclosed herein. During operation, fluid pumped from the fluid chamber mixes with air pumped from an air chamber in the mixing chamber and the resulting mixture is passed through the piezoelectric element and dispensed out of a nozzle.

### CROSS REFERENCE TO RELATED APPLICATIONS

The application claims the benefits of and priority to U.S. Provisional Patent Application entitled “Piezoelectric foaming pump,” Ser. No. 61/353,328 filed on Jun. 10, 2010, which is hereby incorporated by reference in its entirety.

### TECHNICAL FIELD

The present invention generally relates to foaming pumps. Particularly, the present invention relates to a piezoelectric pump used to aerate a liquid, such as soap or sanitizer, to form a foam.

### BACKGROUND OF THE INVENTION

Liquid dispensers, such as liquid soap and sanitizer dispensers, provide a user with a predetermined amount of liquid upon the actuation of the dispenser. Dispensed liquids may be difficult to spread resulting in less than desirable surface coverage on an individual's skin. For example, in the case of liquid sanitizer dispensers, the amount of sanitizer dispensed on an individual's hands is generally confined to a small area requiring the individual to physically spread the liquid around into a larger area in order to increase its coverage over their hands. Unfortunately, this results in waste because many individuals dispense an excess amount of liquid sanitizer to facilitate spreading the liquid over the surface of their skin. Thus, for these, and other reasons, many individuals prefer soap, sanitizer, and moisturizer products that are in a foam product form.

### SUMMARY

A piezoelectric foaming pump is provided herein. The piezoelectric foaming pump includes a housing having a first opening for receiving a liquid from a liquid container and a piezoelectric element secured to the housing. The piezoelectric element includes a plurality of holes there through. In addition, the housing includes an air inlet. Although the piezoelectric element has holes there through, prior to activating the piezoelectric element, liquid does not pass through the plurality of holes. When the piezoelectric element is energized, liquid passes through the plurality of holes due to the rapid vibration of the piezoelectric element and is dispensed as a foam. Additionally, a piezoelectric foaming pump having a fluid pump chamber; an air pump chamber; a mixing chamber; a piezoelectric element; and an outlet nozzle is disclosed herein. During operation, fluid pumped from the fluid chamber mixes with air pumped from an air chamber in the mixing chamber and the resulting mixture is passed through the piezoelectric element and dispensed out of a nozzle.

### BRIEF DESCRIPTION OF THE DRAWINGS

These and other features and advantages of the present invention will become better understood with regard to the following description, and accompanying drawings where:

FIG. 1 is an exemplary cross-sectional view of a piezoelectric foaming pump in accordance with one embodiment of the present invention;

FIG. 2 is another exemplary cross-sectional view of another embodiment of a piezoelectric foaming pump;

FIG. 3 is yet another exemplary cross-sectional view of an embodiment of another piezoelectric foaming pump; and

FIGS. 4 and 5 are exemplary electrical schematics of a drive circuits for piezoelectric foaming pumps.

### DETAILED DESCRIPTION

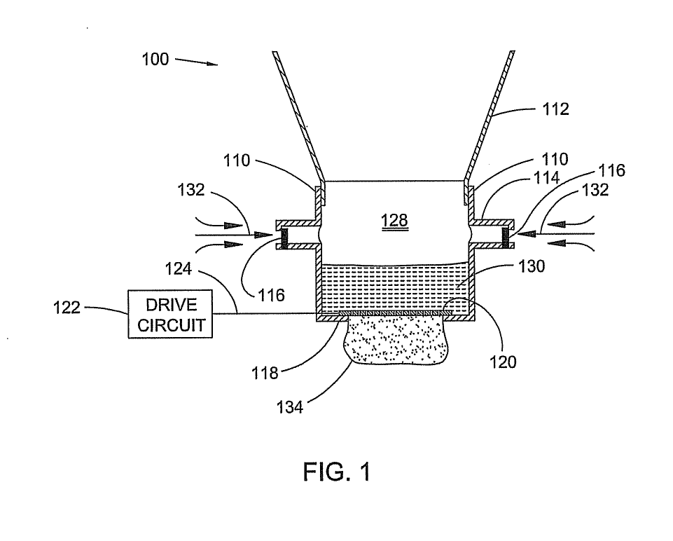

An exemplary embodiment of a piezoelectric foaming pump 100 is illustrated in FIG. 1. Pump 100 includes a body 110 which is connected to a liquid container 112. Liquid container 112 is used to contain a foamable liquid, such as, for example, soap, sanitizer, or moisturizer. Body 110 may be connected to liquid container 112 by any suitable means, such as, for example, a cap (not shown) secured to body 110 and screwed onto a threaded neck (not shown) of the liquid container 112, or welded or bonded by an adhesive to liquid container 112. Body 110 may include one or more air inlets 114. Air inlets 114 contain one-way valves 116, such as for example flapper valves. In addition, body 110 has a bottom surface 118 having an opening therein and is configured to receive a piezoelectric element 120, or atomizer. Piezoelectric element 120 includes a drive circuit 122. Drive circuit 122 provides electrical output signals along line 124 that cause piezoelectric element 120 to vibrate at a high frequency. The output signal may be set to a predetermined frequency, such as, for example 60 Hz. Operation of the piezoelectric element causes air to be drawn in through air inlet 114, past one-way valves 116 and into premix chamber 128. In one embodiment, an air compressor (not shown) is connected to air inlet 114 to force air into premix chamber 128 to mix with the liquid from container 112.

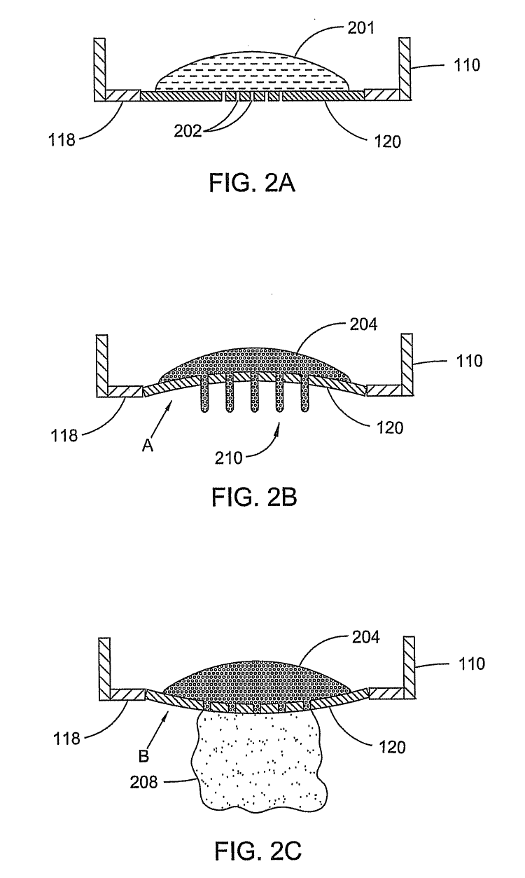

In one embodiment, piezoelectric element 120 is made of a thin perforated stainless steel membrane or mesh. The membrane is preferably an array of micron-sized holes. In one embodiment, the holes 2 (FIG. 2) are sized based upon the density of the foamable fluid. The piezoelectric element 120 is driven at a frequency which causes the membrane to vibrate up and down at a very high speed. In one embodiment, the holes 202 are conically shaped allowing easier passage of the liquid there through or the formation of different sized droplets. In another embodiment, the holes 202 are elongated in shape.

FIGS. 2A through 2C illustrate the piezoelectric element 120 in operation. FIG. 2A illustrates the piezoelectric element 120 during a period of time that no electric signal is being applied. During this time the liquid 201 does not pass through the small holes 202 due to the surface tension of the liquid.

FIG. 2B illustrates the piezoelectric element 120 as it vibrates up to a first position A. The piezoelectric element 120 moves upward, or vibrates at a very fast rate of speed causing the liquid 201 to mix with air to form an liquid/air mixture 204, and causes the liquid/air mixture to be forced through the small holes 202. Resulting in a drip of a liquid/air mixture 206 squeezing through the small holes 202. FIG. 2B illustrates the piezoelectric element 120 vibrated to a second position B. The change in position occurs so fast that the drip of liquid/air mixture is atomized into very tiny particles creating a thick foam 208. The resulting foam 208 is easy for an individual to spread and apply over the surface of his or her skin resulting in a reduction in the amount of liquid material an individual dispenses to achieve suitable coverage and an efficacious result.

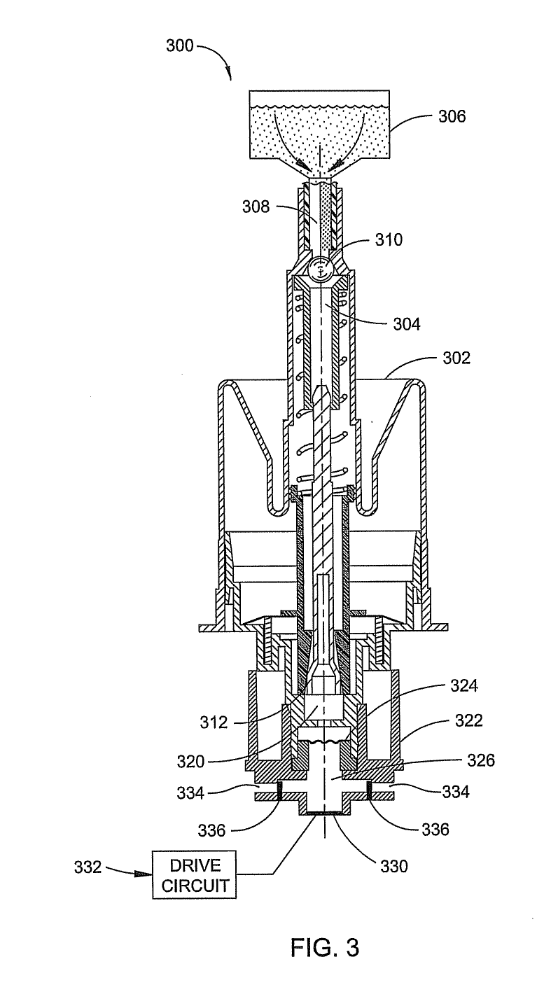

Another exemplary embodiment of a foaming pump 300 is illustrated in FIG. 3. Foaming pump 300 is configured such that as upward pressure is applied to the nozzle 322, an air pump 302 and a liquid pump 304 are simultaneously compressed forcing inlet check valve 310 to seat and causing fluid to flow out of liquid pump 304 past outlet valve 312 and into premix chamber 320. Simultaneously, air is forced out of air pump 302 and into premix chamber 320 where it mixes with the liquid to form a mixture. The mixture is forced through foaming element 324 which may contain one or more screens to form a foam that passes into a post mix chamber 326. Piezoelectric element 330 is driven by drive circuit 332 and vibrates up and down rapidly as describe with respect to FIGS. 2A-2C. Operation of piezoelectric element 330 causes additional air to be drawn into post mix chamber 326 through air inlet chamber 334 and mix with the foam. Optionally, an air compressor may be used to inject additional air into the foam in the premix chamber 326 through inlet passage 334. Check valves 336 prevent foam or air from escaping the post mix chamber through inlet passage 334. In operation, piezoelectric element 330 causes the foam and air mixture to be forced through the piezoelectric element 330 where it is refined. One particularly useful application for such an embodiment is for hard to foam liquids, such as alcohol based liquids. Use of a piezoelectric element 330 enhances the thickness and texture of the foam.

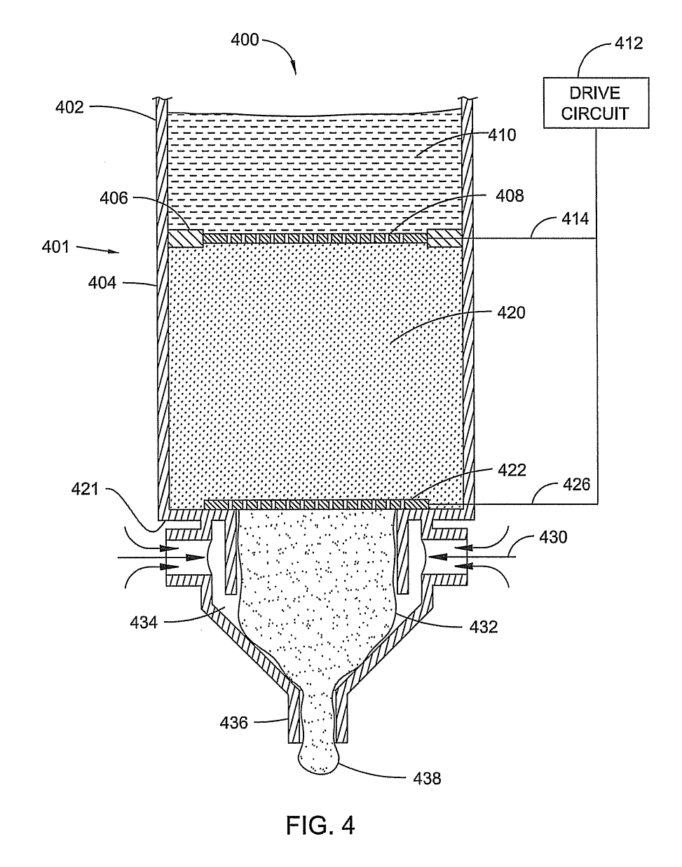

FIG. 4 illustrates yet another exemplary embodiment of a piezoelectric foaming pump 400. The piezoelectric pump 400 includes a liquid container 401 that is separated into an upper chamber 402 and a lower chamber 404. Lower chamber 404 and upper chamber 402 are separated by a partition 406 that includes a first piezoelectric element 408 which is electrically coupled to drive circuit 412 via electrical conductor 414. The lower chamber 404 includes a base 421 that includes a second piezoelectric element 422. Piezoelectric element 422 is connected to drive circuit 412 via electrical conductor 426. Piezoelectric element 408 and piezoelectric element 422 may be driven at the same frequency or at different frequencies. In addition they may be driven for the same duration or for different durations of time. For example, piezoelectric element 408 may be energized earlier then piezoelectric element 422 and operated at a lower frequency to cause liquid 410 to be turned into a fine mist, or atomized droplets 420 and to fill lower chamber 404 prior to energizing piezoelectric element 422. Optionally, if upper chamber 402 contains air, operation of piezoelectric element 408 will also cause mixing of air and liquid in upper chamber prior to passing the fluid to the lower chamber 404 in the form of a mist 420. Once in lower chamber 404 the atomized droplets 420 are pumped through piezoelectric element 422 and turned into a foam 432. In addition, piezoelectric element 422 may be operated for a longer duration then piezoelectric element 408 to empty lower chamber 404.

As the liquid 410 (or liquid/air mixture) passes through the upper chamber 402 and the lower chamber 404 the velocity increases. Thus, in one embodiment as the foam 432 passes through nozzle 436 it is traveling at a velocity sufficient to draw air 430 into nozzle 436 through a venturi effect. The air 430 mixes with the foam to further enhance the foam prior to the enriched foam 438 exiting nozzle 436. In addition, piezoelectric element 408 and piezoelectric element 422 may have the same size holes to pass the liquid or liquid/air mixture or they may have different sized holes.

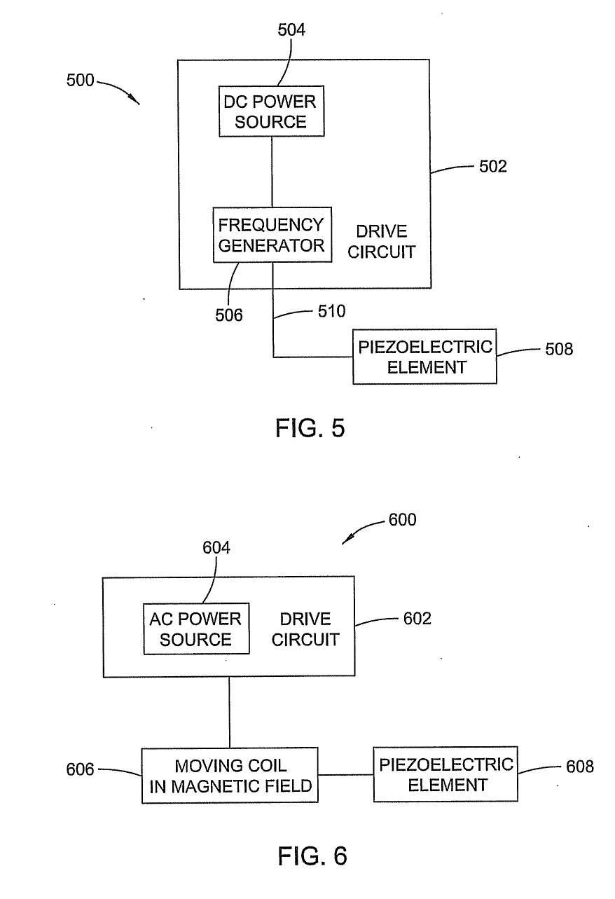

FIG. 5 illustrates an exemplary embodiment of a drive circuit 500 for driving a piezoelectric element 508. Drive circuit 504 includes a DC (direct current) power source 504, such as for example, one or more batteries and a frequency generator 506. Drive circuit 504 includes additional electronic elements readily known to those skilled in the art. Drive circuit 504 may include additional elements, such as a microprocessor (not shown). Thus, drive circuit 504 includes the necessary hardware, software, or combination of both that is suitable for carrying out the functions of the foaming pumps disclosed herein. Frequency generator 506 generates an electrical signal at a predetermined frequency that is communicated to the piezoelectric element 508 via electrical conductor 510. If equipped with a microprocessor (not shown), the microprocessor may be configured in advance with one or more setting modes, which control the specific frequency of the electrical signal generated by the frequency generator 506 to allow for different flow rates or liquid viscosities. In addition, the foaming pumps disclosed herein may also include a setting button (not shown) coupled to the frequency generator 506 or microprocessor to enable an individual to adjust the frequency of the electrical signal generated thereby.

Drive circuit 502 may generate an electrical signal having any suitable frequency, including a frequencies of a hundred KHz or greater. As such, depending on the type of liquid material used by the foaming pumps, the user can adjust the frequency of the electrical signal in a manner to optimize the mechanical vibration of the piezoelectric element 508 to achieve the desired consistency of the generated foam. FIG. 6 illustrates another exemplary drive circuit 600. Drive circuit 600 is powered by an AC (alternating current) power source 604. Drive circuit 600 drives a moving coil in a magnetic field 608 that drives a piezoelectric element 608. Again, drive circuit 600 may include additional hardware and software necessary to drive the piezoelectric element.

One advantage of one or more embodiments of the present invention is that a piezoelectric foaming pump generates foam from liquid material, including but not limited to soap, sanitizer, and moisturizer. Another advantage of the present invention is that the piezoelectric foaming pump generates soap, sanitizer, and moisturizer-based foams that are easily spread on an individual's skin. Still another advantage of the present invention is that the piezoelectric foaming pump reduces waste, as a reduced amount of liquid material is needed to provide an equivalent amount of skin coverage, as compared to that of liquid material pumps.

I/we claim:

1. A piezoelectric foaming pump comprising:
a housing having a first opening for receiving a liquid from a liquid container;
a piezoelectric element secured to the housing and having a plurality of holes there through;
an air inlet into the housing;
wherein prior to activating the piezoelectric element, liquid does not pass through the plurality of holes, and wherein activating the piezoelectric element causes liquid to pass through the plurality of holes and be dispensed as a foam.

2. The piezoelectric foaming pump of claim 1 further comprising an air inlet through the housing, the air inlet including a one-way valve to allow air into the housing and prevent fluid from passing out of the housing through the air inlet.

3. The piezoelectric foaming pump of claim 2 further comprising an air compressor in fluid communication with the air inlet for injecting pressurized air into the housing.

4. The piezoelectric foaming pump of claim 1 comprising a drive circuit configured to output a plurality of frequencies to drive the piezoelectric element at a plurality of different rates.

5. The piezoelectric foaming pump of claim 1 wherein the piezoelectric element is driven by a DC power source.

6. The piezoelectric foaming pump of claim 1 further comprising a liquid container secured to the piezoelectric foaming pump.

7. A piezoelectric foaming pump comprising:
a fluid pump chamber;
an air pump chamber;
a mixing chamber;
a piezoelectric element; and
an outlet nozzle;
wherein during operation, fluid is pumped from the fluid chamber and mixes with air that is pumped from an air chamber in the mixing chamber and wherein the mixture is passed through the piezoelectric element and dispensed out of a nozzle.

8. The piezoelectric foaming pump of claim 7 further comprising an air inlet located upstream of the piezoelectric element, wherein air from the air inlet is drawn in by the action of the piezoelectric element.

9. The piezoelectric foaming pump of claim 7 wherein the liquid pump is a liquid piston pump.

10. The piezoelectric foaming pump of claim 7 wherein the air pump is an air piston pump.

11. The piezoelectric foaming pump of claim 7 further comprising a liquid container wherein the foaming pump is connected to the liquid container.

12. The piezoelectric foaming pump of claim 7 wherein the fluid pump chamber and the air pump chamber are coaxial.

13. The piezoelectric foaming pump of claim 7 further comprising a foaming element, wherein the mixture passes through the foaming element prior to passing through the piezoelectric element.

14. The piezoelectric foaming pump of claim 7 further comprising an piezoelectric element drive circuit that has a plurality of frequency settings.

15. A piezoelectric foaming pump comprising:
a housing having a plurality of chambers,
a first piezoelectric element located between a first and second chamber;
a second piezoelectric element located downstream of the second chamber;
wherein fluid enters the housing and passes through the first piezoelectric element wherein the fluid is atomized; and
wherein the atomized fluid passes through the second piezoelectric element and is output as a foam.

16. The piezoelectric foaming pump of claim 15 further comprising an air inlet located downstream of the second piezoelectric element and wherein air is drawn into the air inlet through a venturi effect.

17. The piezoelectric foaming pump of claim 15 further comprising a liquid container secured to the piezoelectric foaming pump.

18. The piezoelectric foaming pump of claim 15 wherein the fluid passing through the first piezoelectric element is a mixture of a liquid an air.

19. The piezoelectric foaming pump of claim 15 further comprising an piezoelectric element drive circuit that has an adjustable frequency setting.

20. The piezoelectric foaming pump of claim 15 wherein the liquid is gravity fed to at least one of the piezoelectric elements.
